(19) United States
(12) Patent Application Publication
(10) Pub. No.: US 2005/0199498 A1
(43) Pub. Date: Sep. 15, 2005

(54) Purification of blood clotting proteins

(75) Inventors: Chenicheri Hariharan Nair, Baulkham Hills (AU); Dennis Bryan Rylatt, Ryde (AU); Andrew Mark Gilbert, Lane Cove (AU)

Correspondence Address: MORGAN LEWIS & BOCKIUS LLP, 1111 PENNSYLVANIA AVENUE NW, WASHINGTON, DC, 20004, US

(73) Assignee: GRADIPORE LTD New South Wales Australia

(21) Appl. No.: 09/787,368

(22) Filed: Mar. 14, 2001

Related U.S. Application Data
(63) Continuation of application No. PCT/AU99/00653, filed on Aug. 11, 1999.

(30) Foreign Application Priority Data
Aug. 12, 1998 (AU) PP5212

(51) Int. Cl. G01L 1/20; C02F 1/469

(52) U.S. Cl. 204/450; 204/600

(57) ABSTRACT

A method of separating a blood clotting protein from a mixture of blood clotting protein and at least one contaminant, the method comprising: (a) placing a blood clotting protein and contaminant mixture in a first solvent stream, the first solvent stream being separated from a second solvent stream by a first electrophoretic membrane; (b) selecting a buffer for the first solvent stream being a pH greater than the isoelectric point of the blood clotting protein; (c) applying an electric potential between the first and second solvent streams causing movement of at least some of the contaminants through the membrane into the second solvent stream while the blood clotting protein is substantially retained in the first solvent stream, or if entering the membrane, being substantially prevented from entering the second solvent stream; (d) optionally periodically stopping and reversing the electric potential to cause movement of any blood clotting protein having entered the membrane to move back into the first solvent stream, wherein substantially not causing any contaminants that have entered the second solvent stream to re-enter first solvent stream; and (e) maintaining step (c) until the first solvent stream contains the desired purity of blood clotting protein substantially mimicking the characteristics of natural blood clotting protein.

### TECHNICAL FIELD

The present invention relates to methods for obtaining blood clotting proteins, particularly fibrinogen, in a substantially unmodified and natural state.

### BACKGROUND ART

The conversion of fibrinogen to fibrin forms the infrastructure upon which other components of blood interact in haemostasis. Fibrin also has other functional roles in a myriad of physiological processes including wound healing, tumour growth and bone fracture repair. Purified fibrinogen is used as a haemostatic adjuvant in the production of fibrin glue used as a “bandage” in various forms of surgery and has found particular roles in cardiovascular and neuro-surgery. The separation of fibrinogen from plasma, however, has always been a limiting factor in the fibrin glue industry and in the research laboratory. Methods available currently can take up to three days with very poor yields, ranging from 40% to 60%, dependant on the method used and the time taken. A major source of concern is the wastage of other potentially important proteins in blood that are discarded in the first purification step when using the frequently employed procedure of ethanol precipitation.

Fibrinogen is only sparingly soluble in water but can also be readily salted out with neutral salts such as sodium chloride and ammonium sulphate. The characteristics of this clotting protein differs quite markedly from other proteins in that it has reduced solubility at low temperatures. Fibrinogen can be precipitated with modest concentrations of PEG or water miscible organic solvents.

Traditional precipitation methods, however, have a number of disadvantages. Several proteins other than fibrinogen having similar physicochemical properties or binding affinity for fibrinogen and tend to coprecipitate during precipitation. This contamination leads to the need for complex subsequent purification steps using different precipitating agents which seriously impair the yield of the purified fibrinogen and results in undesirable modification of the final product.

Although the starting material, plasma, can be obtained in large amounts, the cost of the materials employed and the time taken to achieve purification are all important variables in considering which method should be commercially employed for the purification of fibrinogen. Presently, most commercial schemes for fibrinogen isolation are based on solubility properties of fibrinogen. The purification procedure employed by Kabi (Stockholm) includes alcohol precipitation, cryoprecipitation, barium sulphate adsorption, glycine extraction and acetone precipitation at low temperature. The result is 30-40% yield with high clottability.

Furthermore, the isolated or purified fibrinogen has characteristics dissimilar to natural fibrinogen in plasma (Nair et al 1986). A major determinant of the quality and functionality of a blood clot and also its role as fibrin resides in the “nativity” of the fibrinogen. Nativity refers to the functionality and molecular similarity of the protein to that when it is in a physiological milieu. Current separation methods produce fibrinogen that is “harshly” treated using chemical and physical separation techniques that ultimately denature the fibrinogen.

The present inventors have developed new methods for the purification of native and functional fibrinogen.

### DISCLOSURE OF INVENTION

In a first aspect, the present invention consists in a method of separating blood clotting protein from a mixture of blood clotting proteins and at least one contaminant, the method comprising:
(a) placing a blood clotting protein and contaminant mixture in a first solvent stream, the first solvent stream being separated from a second solvent stream by a first electrophoretic membrane;
(b) selecting a buffer for the first solvent stream being a pH greater than the isoelectric point of the blood clotting protein;
(c) applying an electric potential between the first and second solvent streams causing movement of at least some of the contaminants through the membrane into the second solvent stream while the blood clotting protein is substantially retained in the first solvent stream, or if entering the membrane, being substantially prevented from entering the second solvent stream;
(d) optionally periodically stopping and reversing the electric potential to cause movement of any blood clotting protein having entered the membrane to move back into the first solvent stream, wherein substantially not causing any contaminants that have entered the second solvent stream to re-enter first solvent stream; and
(e) maintaining step (c) until the first solvent stream contains the desired purity of blood clotting protein substantially mimicking the characteristics of natural blood clotting protein.

In a preferred embodiment, the method further includes the steps of:
(f) replacing the first electrophoretic membrane with a second electrophoretic membrane having a molecular mass cut-off greater that of the first membrane;
(g) applying an electric potential between the first and second solvent streams causing movement of at least some of the contaminants through the second membrane into the second solvent stream while the blood clotting protein is substantially retained in the first solvent stream, or if entering the second membrane, being substantially prevented from entering the second solvent stream;
(h) optionally periodically stopping and reversing the electric potential to cause movement of any blood clotting protein having entered the second membrane to move back into the first solvent stream, wherein substantially not causing any contaminants that have entered the second solvent stream to re-enter first solvent stream; and
(i) maintaining step (g) until the first solvent stream contains the desired purity of blood clotting protein substantially mimicking the characteristics of natural blood clotting protein.

Preferably, the mixture is plasma obtained from blood and the blood clotting protein is fibrinogen.

In a further preferred embodiment of the first aspect of the present invention, the first electrophoretic membrane has a molecular mass cut-off close to the apparent molecular mass of fibrinogen, preferably about 300 kDa.

Preferably, the second electrophoretic membrane has a molecular mass cut-off greater than the first electrophoretic membrane, preferably about 1000 kDa.

The buffer pH of the solvent streams is preferably about 6.0. Major protein contaminants including albumin whose pI is 4.9 are separated from the fibrinogen as the contaminants are transferred into the second solvent stream. A buffer particularly suitable for step (b) is Mes/Histidine pH 6.0. It will be appreciated, however, that many other buffers would be suitable for use in the method according to the present invention.

The present inventors have been able to obtain recoveries of fibrinogen from blood plasma of at least 70% and having about 95% clottability. The method is relative fast taking around 3 hours.

Further benefits of the method according to the first aspect of the present invention are the possibility of scale-up, and the removal of microbial pathogens/contaminants that may be present in the starting material without adversely altering the properties of the purified fibrinogen.

In a second aspect, the present invention consists in use of Gradiflow™ technology in the purification and/or separation of fibrinogen substantially mimicking the characteristics of natural fibrinogen.

In a third aspect, the present invention consists in fibrinogen substantially mimicking the characteristics of natural fibrinogen purified by the method according to the first aspect of the present invention.

In a fourth aspect, the present invention consists in substantially isolated fibrinogen substantially having the clotting and functional characteristics of native fibrinogen.

In a fifth aspect, the present invention consists in use of fibrinogen according to the fourth aspect of the present invention in medical and veterinary applications.

It will be appreciated that the fibrinogen according to the present invention would be suitable for use in fibrin glue, isolating and researching of fibrinogen in dysfibrinogenaemias, inclusion of fibrin in vascular grafts and other wound healing aids.

In a sixth aspect, the present invention consists in a method of separating blood clotting protein from a mixture including blood clotting protein and at least one contaminant, the blood clotting protein and the at least one contaminant each having a respective size and a respective charge, the method comprising the steps of:
exposing the mixture to an electric field in the presence of an electrophoretic membrane having a defined pore size to thereby separate at least a portion of the blood clotting protein and the at least one contaminant onto opposite sides of the membrane in accordance with differences in at least one of the size and charge between the blood clotting protein and the at least one contaminant;
maintaining the exposing step for a period not greater than 48 hours; and
recovering from the mixture not less than 40% of the blood clotting protein content of the mixture.

In a seventh aspect, the present invention consists in a method of separating a blood clotting protein from a mixture including blood clotting protein and at least one contaminant, the blood clotting protein and the at least one contaminant each having a respective size and a respective charge, the method comprising the steps of:
exposing the mixture to an electric field in the presence of an electrophoretic membrane having a defined pore size to thereby separate at least a portion of the blood clotting protein and the at least one contaminant onto opposite sides of the membrane in accordance with differences in at least one of the size and charge between the blood clotting protein and the at least one contaminant;
maintaining the exposing step for a period not greater than 48 hours; and
recovering from the mixture a blood clotting protein, wherein in a clotting test the blood clotting protein produces fibrins in a clot having a mass to length ratio similar to that obtained with plasma in the same clotting test.

In a eighth aspect, the present invention consists in a method of separating blood clotting protein from a mixture including blood clotting protein and at least one contaminant, the blood clotting protein and the at least one contaminant each having a respective size and a respective charge, the method comprising the steps of:
exposing the mixture to an electric field in the presence of an electrophoretic membrane having a defined pore size to thereby separate at least a portion of the blood clotting protein and the at least one contaminant onto opposite sides of the membrane in accordance with differences in at least one of the size and charge between the blood clotting protein and the at least one contaminant;
maintaining the exposing step for a period not greater than 48 hours; and
recovering from the mixture a blood clotting protein, wherein in a clotting test the blood clotting protein produces a clot having fibrin network compaction similar to that obtained with plasma in the same clotting test.

In a ninth aspect, the present invention consists in a method of separating blood clotting protein from a mixture including blood clotting protein and at least one contaminant, the blood clotting protein and the at least one contaminant each having a respective size and a respective charge, the method comprising the steps of:
exposing the mixture to an electric field in the presence of an electrophoretic membrane having a defined pore size to thereby separate at least a portion of the blood clotting protein and the at least one contaminant onto opposite sides of the membrane in accordance with differences in at least one of the size and charge between the blood clotting protein and the at least one contaminant;
maintaining the exposing step for a period not greater than 48 hours; and
recovering from the mixture a blood clotting protein having a purity of not less than 90%.

The inventors have found that the present invention is particularly suitable for fibrinogen separation. It will be appreciated, however, that other blood clotting proteins, including thrombin, factor VIII, alpha 2 macroglobulin and plasminogen would also be expected to be separated in a more natural state by the present invention.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

In order that the present invention may be more clearly understood, preferred forms will be described in the following example with reference to the accompanying drawing.

### BRIEF DESCRIPTION OF DRAWINGS

FIG. 1 is a schematic representation of pore size separation/purification achieved by Gradiflow™ technology.

FIG. 2 shows native SDS PAGE analysis of a fibrinogen purification process according to the present invention, where Lane 1: Molecular weight markers; Lane 2: Plasma; Lane 3: Upstream 1 hour; Lane 4: Upstream 90 minutes; Lane 5: Upstream 2 hours; and Lane 6: ADI Grade L Fibrinogen.

FIG. 3 shows Western analysis of a fibrinogen purification process according to the present invention, where Lane 1: Plasma; Lane 2: Upstream 1 hour; Lane 3: Upstream 90 minutes; Lane 4: Upstream 2 hours; Lane 5: Upstream 2 hours lyophilised; and Lane 6: ADI Grade L Fibrinogen.

FIG. 4 shows reduced SDS PAGE analysis of a fibrinogen purification process according to the present invention where Lane 1: Molecular weight markers; Lane 2: ADI Grade L Fibrinogen; Lane 3: Plasma; Lane 4: Upstream 1 hour; Lane 5: Upstream 2 hours; and Lane 6: ADI Grade L Fibrinogen.

FIG. 5 shows clotting curves of plasma, a sample of fibrinogen produced according to the present invention, and a commercial sample of fibrinogen.

FIG. 6 shows PAGE analysis of fibrinogen purification from cryo-precipitate 1 where Lane 1: Molecular weight markers; Lane 2: Cryo-precipitate 1; Lane 3: Upstream 1 hour; Lane 4: Upstream 2 hours; Lane 5: Upstream 3 hours; Lane 6: Downstream zero; Lane 7: Downstream 1 hour; Lane 8: Downstream 2 hours; Lane 9: Downstream 3 hours; and Lane 10: ADI Grade L Fibrinogen.

### MODES FOR CARRYING OUT THE INVENTION

Methods

Gradiflow™ Technology

The Gradiflow™ comprises of three separate flow streams (sample, product and buffer) that feed into the membrane cartridge housed inside the separation unit where they are sandwiched between porous polyacrylamide membranes.

Some additional aspects of the Gradiflow™ technology are further described in U.S. Pat. No. 5,039,386 and U.S. Pat. No. 5,650,055, which US Patents are owned by the owners of the present invention and which US Patents are hereby incorporated by reference.

Gradiflow™ Principle

Proteins exist as charged molecules above or below their isoelectric point (PI). In the Gradiflow™, the net charge on a macromolecule is controlled by the choice of buffer pH. The proteins are separated in an electric field by charge and/or size differences.

Charge and/or Size Based Separations

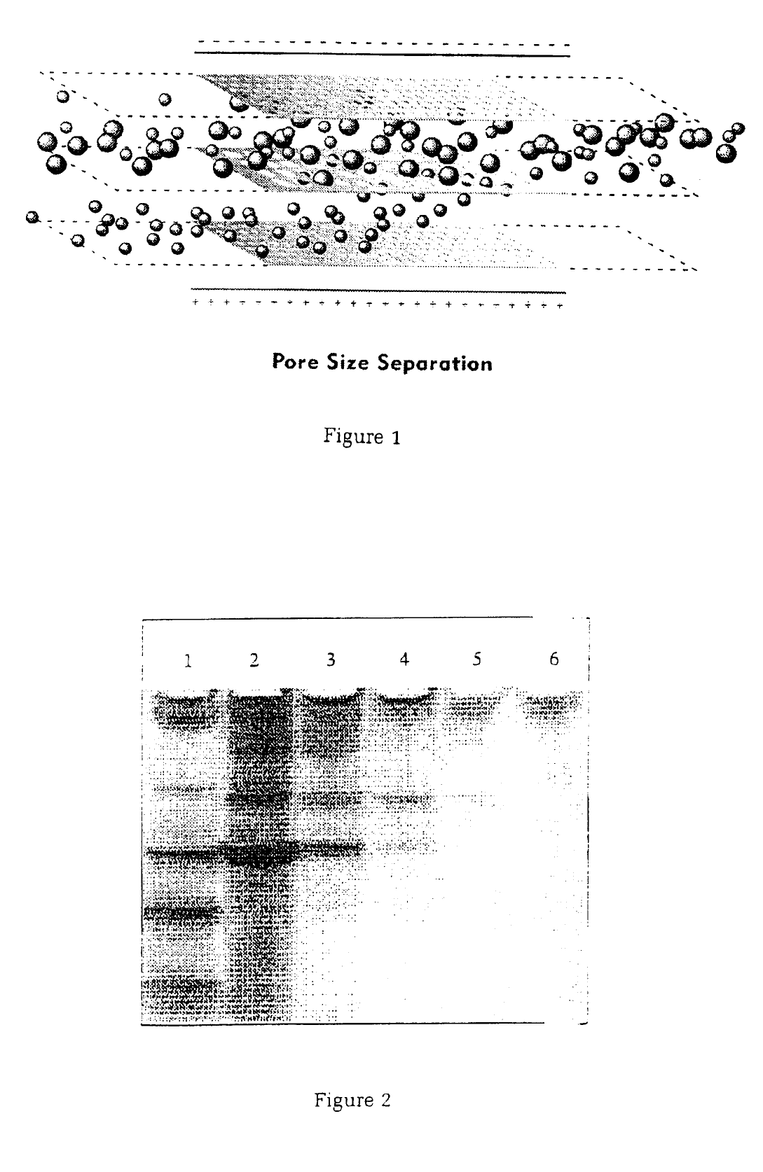

It has now been demonstrated by the present inventors that one of the great advantages of the Gradiflow™ separation system is that a protein can be separated based on the dual characteristics of size and charge. For charge-based separations, a pH is selected between the isoelectric points of two proteins such that one protein will have a positive charge and the other a negative charge. In the example illustrated in FIG. 1, a protein mixture continuously circulates in the upstream compartment. When an electrical potential is applied, the negatively charged molecules migrate across the separation membrane to the downstream towards the positive electrode under the influence of an electric field. All other molecules are retained in the upstream. Altering the pore size of the intervening separation membrane allows separations to be performed by size and/or charge.

Purification of Fibrinogen

Phase 1

In one particular example, whole blood was collected in 3.8% sodium citrate in a ratio of 9 parts blood to 1 part anticoagulant. The blood was then centrifuged at 6000 g. The resultant supernatant was centrifuged again at 3000 g to give essentially platelet poor plasma (PPP) (<3000 platelets/Tl). Each sample of PPP was then diluted with three volumes of 80TM Tris Borate buffer (pH 8.5). This same buffer was selected as the running buffer. A buffer pH of 8.5 ensured that most of the proteins in plasma had a negative charge, including fibrinogen. A Gradiflow™ separation cartridge with a molecular mass cut off of 300 kDa was selected, as this would ensure that all other proteins below 300 kDa would be separated from plasma when the electrical field was turned on. The Phase one separation according to this example was run for 1 hour with the downstream harvested every 20 minutes and replaced with fresh buffer. A maximum voltage of 250V and maximum current of 1A was applied across the cartridge.

Phase 2

In this example, the isolated protein mixture from the upstream of Phase 1 was used in Phase 2. Separation was achieved using running conditions identical to those used in Phase 1, except that the separation membrane had a 1000 kDa cut off. The Gradiflow™ was run for 1 hour with the downstream harvested every 20 minutes and replaced with fresh TB. This strategy enabled the removal of proteins in plasma with a molecular weight greater than 300 kDa.

Phase 3

The upstream product of Phase 2 was further processed in this example at pH 6.0 using a MES/Histidine buffer. The Gradiflow™ system was run for 1 hour at 300V reversed polarity with a 1000 kDa cut-off separation membrane and the downstream removed for analysis. The upstream was harvested for further analysis. This exemplary strategy enabled the removal of IgG contamination as the immunoglobulins were charged at pH 6.0 and migrated across the separation membrane and away from the fibrinogen sample.

Characterisation of Fibrinogen

SDS PAGE, native PAGE (Laemmli, 1970) and Western blot analysis (Towbin et al, 1979) were carried out on sample from both the up and down streams in the examples of the present invention. All electrophoresis gels were Gradipore™ Tris-glycine gels.

SDS PAGE

SDS PAGE was performed using Tris-glycine-SDS running buffer, SDS PAGE samples were prepared using 40 microlitres Gradipore™ glycine sample buffer, 10 microlitres DTT, 50 microlitres sample and were boiled for 5 minutes. SDS PAGE was run at 150V and 500 mA for 90 minutes.

Native PAGE

Native PAGE was performed using Tris-glycine running buffer. Native PAGE samples were prepared using 25 microlitres native sample buffer and 50 microlitres sample. Native PAGE was run at 200V and 50 mA for 90 minutes.

All SDS and native PAGE were stained with Gradipure™ (coomassie stain) (Gradipore, Sydney, Australia).

Western Analysis

Western analysis was carried out as described by Towbin et al (1979) on selected SDS and native PAGE. Blotting filter paper and nitrocellulose blotting membrane were pre-soaked in Towbin buffer for 60 minutes. Protein transfer was performed in semi-dry blotting apparatus (Macquarie University, Sydney Australia) at 12V for 90 minutes. The membrane was washed with PBS for 5 minutes, blocked with 1% skim milk in phosphate buffered saline for 10 minutes. The membrane was stained with 20 Tl rabbit anti-human fibrinogen conjugated to horseradish peroxidase (HRP) (DAKO A/S, Denmark) in 10 Tl 1% skim milk solution for 60 minutes. The stain was developed with 4CN diluted one part in five in PBS to a volume of 10 ml and 10 microlitres H₂O₂. Development of the blot occurred within 30 minutes.

Sample concentration was performed using an Amicon stirred cell ultrafiltration apparatus (Amicon). The fibrinogen sample, with an initial volume of 60 mL was placed in the pressure chamber with pressure of 50 psi and concentrated using a 30 kDa cut off membrane and collected in a beaker. The pH of the concentrate was adjusted to 7.3 for clotting assays.

Fibrinogen Recovery

An in-house enzyme-linked immunoassay (EIA) was used to quantitate the recovery of fibrinogen through the Gradiflow™ purification process. Anti-human fibrinogen monoclonal antibody 3D5 (supplied by AGEN, Queensland, Australia) in PBS and 0.5% sodium azide was applied to the ELISA plate and incubated at room temperature for 1 hour. At the completion of the incubation, the plate wells were washed three times with PBS/Tween 20 for two minutes. Fibrinogen standards (American Diagnostica, Grade L) and Gradiflow™ fibrinogen samples were applied to appropriate wells and the plate was incubated on a shaker for 20 minutes. The plate was again washed three times with PBS/Tween 20 for two minutes. The secondary antibody, rabbit and human fibrinogen conjugated to HRP (DAKO A/S, Denmark), was applied and allowed to incubate on a shaker for 20 minutes. The plate was then washed three times with PBS/Tween 20 for two minutes. Samples were then developed using ABTS solution and 3% H₂O for 20 minutes and stopped with 3.9% oxalic acid. The plate was read with an ELISA plate reader (BioRad, USA).

Fibrinogen Characterisation

Thrombin Clotting Curves

Clotting curves were generated to illustrate the conversion of Gradiflow™ fibrinogen to fibrin. To 0.9 mL fibrinogen solution was added 0.1 mL thrombin/calcium mixture (final concentrations of 0.5 Tl/mL thrombin (Bovine Thrombin, Sigma, USA) and 10 mM CaCl₂). The progression of polymerisation was observed using optical density readings at 600 nm plotted against time.

Clotting curves of Gradiflow™ fibrinogen, a fibrinogen standard and plasma were compared.

Mass to Length Ratio

Mass to length ratio (Carr and Hermans 1976) was used to quantitate fibrin fibre thickness of fibrin network structures. To 0.9 mL fibrinogen solution was added 0.1 mL thrombin/calcium mixture (final concentrations of 10 Tl/mL thrombin and 10 mM CaCl₂) and left at room temperature for 1 hour for clot stabilisation. Optical density readings were recorded at 800 nm with unclotted fibrinogen used as the reference. Mass to length ratio (Tᵣ) of fibrin fibres was calculated from measurements of turbidity at 800 nm and is given by:

$$ur = \frac{34.59 * T * 10}{clottability * c}$$

where T represents the turbidity of the fibrin matrix and is calculated by multiplying the optical density at 800 nm by e¹ and c is the concentration of fibrinogen in solution. The units of fibrin fibre thickness are Daltons/cm.

The mass to length ratio of Gradiflow™ fibrin fibres was compared with that of plasma, and a commercial standard.

Compaction (Nair et al 199?)

Fibrin networks were prepared from plasma, purified fibrinogen solutions (ADL, USA) and Gradiflow™ fibrinogen, in 1.5 mL eppendorf microfuge tubes, pre-sprayed with a lecithin based aerosol. To each 0.9 mL fibrinogen solution was added to 0.1 mL thrombin/calcium mix (final concentrations of 10 NIH units/mL thrombin and 10 mM CaCl₂) and left at room temperature for 1 hour for clot stabilisation. The networks were centrifuged at 8000×g for 1 minute in a microcentrifuge (Zentrifuge 3200, Eppendorf, Germany). The volume of the supernatant expelled from the network was measured with a 1 mL Hamilton glass syringe and expressed as a percentage of the initial network volume.

Results

Fibrinogen Purification

FIG. 2 is a native PAGE of an example of a purification according to the present invention. Lanes 3 and 4 illustrate the removal of contaminating proteins using 80 mM Tris Borate (pH 8.4) running buffer from plasma (FIG. 2, lane 2).

In this example, the pH of the buffer resulted in all components of plasma with a pI below 9.0 becoming negatively charged. Conversely, all proteins with a pI higher than 9.0 were positively charged. When a voltage was placed across the separating membrane (300 kDa cut off), charged species migrated toward the electrode of opposite charge. Most protein contaminants were removed within one hour. Although fibrinogen was charged, the low charge to mass ratio placed upon the molecule at pH 9.0 resulted in the slow migration of the molecule. Added to this was the difficulty encountered in moving fibrinogen (34 kDa) across any separating membrane. The difficulty was attributed to the elongated shape of fibrinogen. Fibrinogen's Stoke's radius makes it appear much larger when it is pushed through membrane pores than is molecular mass dictates. Furthermore, fibrinogen self associates, forming lager molecular weight aggregates that cannot migrate through the separation membrane.

Phase 2 of the fibrinogen purification was carried out in TB buffer at pH 9.0. The high salt concentration (80 mM) assisted in retaining fibrinogen in solution throughout the procedure. The high pH utilised resulted in most of the protein contaminates present becoming negatively charged. The pore size of the second separation membrane (1000 kDa cut off) did not restrict the migration of most of the low molecular weight proteins that were present after the citrate buffer purification whilst at the same time restricting the migration of fibrinogen into the waste stream.

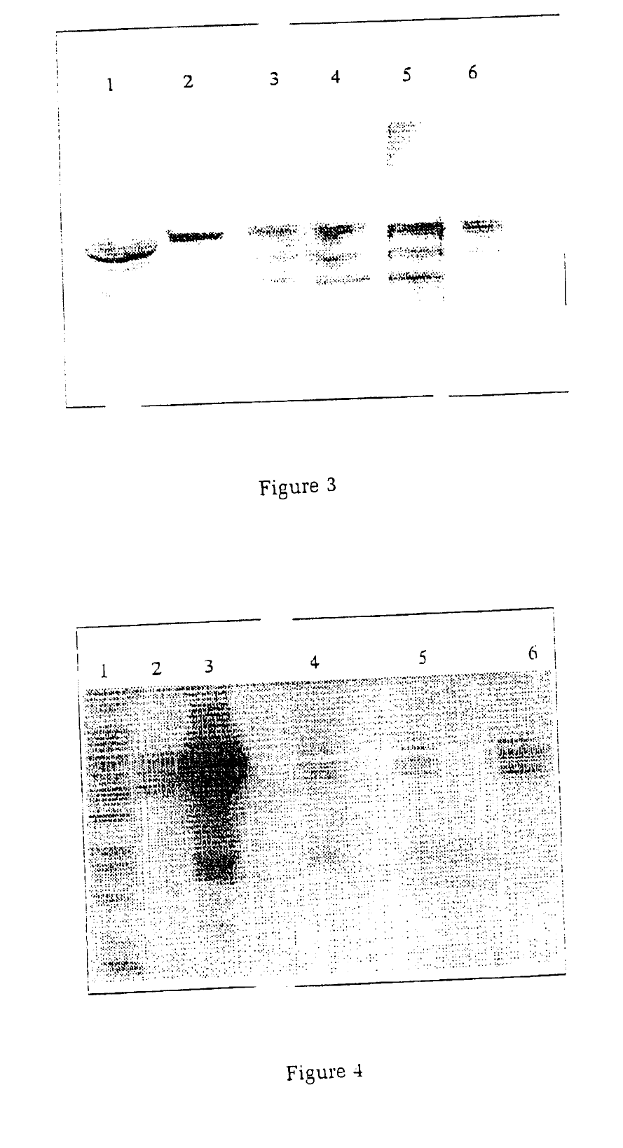

Western analysis of examples of Gradiflow™ fibrinogen confirmed the presence of fibrinogen initially observed in both reduced and native gels. In the present example, Western blot (FIG. 3) illustrates the progression of fibrinogen, through the two phases of the purification protocol. Lane 1 illustrates the presence of large volumes of impurities with the fibrinogen bands appearing bloated by interference from albumin. It is evident in this example after phase 1 of the purification that the albumin was removed resulting in the fibrinogen bands becoming far more defined (FIG. 3, lane 2).

The presence of plasminogen in the fibrinogen was confirmed with the use of plasminogen standard solution, run adjacent to the fibrinogen solution on both reduced SDS PAGE and native PAGE. Plasminogen has in the past been one of the protein contaminants in fibrinogen solutions that has proved difficult to remove without a separate procedure. This can be explained by specific binding of fibrin(ogen) and plasminogen in blood plasma. Lysine sepharose affinity columns have been traditionally used to remove plasminogen.

Other contaminating protein components could also be visualised by PAGE in this example. The low molecular band in the reduced PAGE (FIG. 3) is believed to be the light subunit chain of IgG. The high pI range of IgG (6-9) resulted in little or no charge of the molecule at pH 8.5. Phase 3 removed this contamination using a charged-based separation strategy at pH 6.0.

The remaining contaminants were not removed in the initial two phases of the purification for one of three reasons.

Firstly, the pI of the contaminants may have been somewhat close to or above pH 8.5, the pH of the TB separation buffer utilised in the isolation. An unusually high isoelectric point may have resulted in the contaminants not becoming negatively charged at pH 8.5, hence the contaminants were not attracted to the positive electrode through the separation membrane.

Secondly, the size of the contaminants may not have been as large or larger than that of fibrinogen and, as a result, their migration across the separation membrane was restricted by the pore size of the membrane.

Finally, the contaminating components of the preparation may have been members of a fibrinogen complex in vivo. That is, the contaminants were physically bound to fibrinogen in its physiological state, and their close relationship with fibrinogen was of biological importance. The buffers utilised in the isolation were so mild that the fibrinogen isolated was done so with other bound components, as a single entity, as it is found in plasma. The intimate relationship of the contaminating proteins and fibrinogen was not disturbed by the purification procedure.

As the Gradiflow™ was used to isolate native fibrinogen in these examples, the contaminants present on the reduced and native gels may in fact be proteins that bind to fibrinogen in vivo. The presence of these proteins may be essential for biological functionality. Prior art fibrinogen preparations presently commercially available attempt to remove these components from solution in the process reducing the nativity of the fibrinogen and hence the final network produced when it polymerises.

Examples of fibrinogen purifications demonstrated in this specification were completed in approximately three hours. These recoveries are in contrast to prior art fibrinogen isolation methods that are completed in about 72 hours. The Gradiflow™ method for blood clotting proteins allowed a rapid separation of fibrinogen having the desired nativity.

The addition of serine protease and calcium ions resulted in the formation of a visible clot in the fibrinogen solution in the examples, thus confirming that clotting activity was retained in Gradiflow™-isolated fibrinogen. Further studies on some of the examples were carried out characterising the network structure of the insoluble gel formed upon thrombin and calcium addition.

Fibrinogen Recovery

Conventional fibrinogen purification protocols recover approximately 35% to 40% of the fibrinogen content of plasma (Furlan 1984). Industrially, fibrinogen yields are closer to 6% with losses commonly attributed to the use of complex procedures during which fibrinogen was co-precipitated and co-eluted with contaminating proteins. In contrast, use of the Gradiflow™ technology for separation of blood clotting proteins, fibrinogen yield is over 72%. This provides an unexpected and advantageous advance over the prior art purification schemes. Tables 1 and 2 compare examples of fibrinogen recovery using the Gradiflow™ to conventional protocols.

TABLE 1
Summary of comparison of commercially available fibrinogen with
fibrinogen isolated by the Gradiflow ™ technology

| Comparators | *Commercial Fibrinogen | Gradiflow ™ |
|---|---|---|
| Separation time | 48-72 hours | 3 hours |
| Separation media | harsh chemicals | mild buffers |
| Co-precipitation | Yes | No |
| Yield | 30-40% | >70% |
| Purity (SDS PAGE) | 90% | 95% |
| Clottability | High | High |
| Solubility | Low | High |
| Nativity | No | Yes |
| Vector and bacterial | | |
| removal | Separate procedure | Achievable |
| Cost | High | Low |

*Furlan, M (1984).

TABLE 2
Fibrinogen yield comparison

| Sample | Yield (%) |
|---|---|
| Gradiflow ™ | 79 |
| Conventional purification | 40 |
| Commercial preparation | 10 |

Characterisation of Gradiflow™ Fibrinogen

The nativity of fibrinogen is best measured by the structure of the matrix produced when clot is formed. Close similarity with a blood clot indicates that the preceding fibrinogen is as found in plasma. Fibrin fibre thickness and the tensile strength of the clot were two characteristics investigated in an attempt to compare the nativity of Gradiflow™ fibrinogen with plasma fibrinogen and a commercial preparation produced using precipitation, column chromatography and traditional electrophoresis.

Clotting curves describe the conversion of fibrinogen to fibrin with the addition of thrombin. The initial lag phase indicates the time taken for the conversion of fibrinogen to activated fibrin monomers. This is described as the clotting time of fibrinogen and is indicative of fibrinogen activity. The rate of rise phase proceeding this phase illustrates the rate of polymerisation of fibrin monomers and results in the production of a stable clot as described by the plateau of the curve.

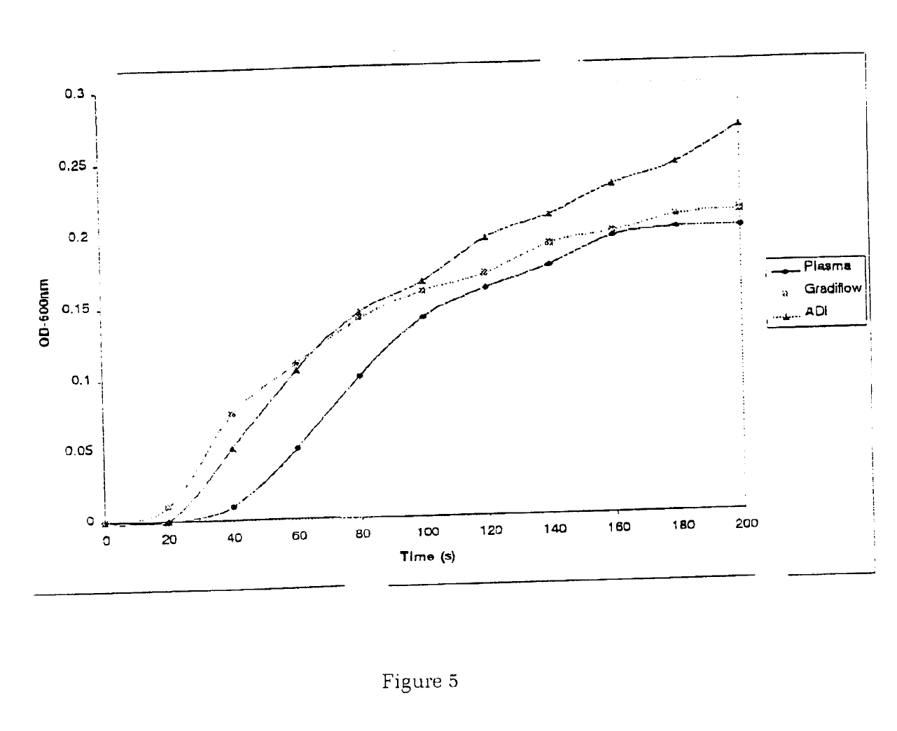

FIG. 5 illustrates the production of a clot from plasma, Gradiflow™ fibrinogen from one of the examples and a commercial standard. It is evident that the clotting times and rate of rise for Gradiflow™ fibrinogen and the commercial standard differ markedly from that of plasma. The similarity of the stable plasma clot and that of a Gradiflow™ fibrin network, however, is indicative of the similarity of Gradiflow™ fibrinogen with that found in native plasma.

Mass to Length Ratio

Mass to length ratio is a biophysical assay, measuring the thickness of fibrin fibres when clotted with thrombin. The removal of fibrino-peptides is a kinetic process that results in the polymerisation of activated fibrin molecules. There are several factors that influence the physical nature of clot fibres, including fibrinogen and thrombin concentrations, calcium ion concentration and the presence of other protein components in the fibrinogen solution.

Clot fibre characteristics are a measure of the preceding fibrinogen nativity. Blood plasma contains all of the required elements for the production of a fully effective clot. Blood clots contain fibrin fibres that are coarse and numerous, a result of complex interactions from hundreds of blood components including platelets, fibronectin and plasminogen. When clotted, purified fibrinogen solutions produce fibrin fibres that are relatively fine and sparse. This contrast with blood clots is attributed to the removal of essential related elements from the surrounding environment and a subsequent alteration of the kinetics of clot formation.

Table 3 illustrates the difference in mass to length ratio of a plasma clot and that produced from a commercial fibrinogen standard. Gradiflow™ fibrin fibres were thicker than those produced from the commercial preparation, suggesting that the example of the Gradiflow™ fibrinogen is more like plasma fibrinogen than current commercial preparations.

TABLE 3
Mass to length ratios, a measure of fibrin fibre thickness

| Sample | Ratio |
|---|---|
| Plasma | 65 |
| Gradiflow ™ | 35 |
| Commercial preparation | 20 |

Fibrin fibre comparison of different fibrinogen solutions is a good indicator of fibrin nativity, however, in conjunction with clot compaction a more detailed explanation of fibrin network structure can be obtained.

Compaction

Compaction is an indicator of the tensile strength of fibrin network structures. The cross-linking of adjacent fibrin fibres provides a clot with its characteristic network structure and results in the matrix retaining form when placed under physiological stresses. Commercial fibrinogen separations clot to form a structure that is high in tensile strength and as a result they do not act in the same manner as a blood clot when placed in situ. The nativity of Gradiflow™ fibrinogen is illustrated by the compaction of a clotted sample (Table 4). The manner in which it acts to stresses is similar to that of blood plasma and this was attributed to the isolation of a fibrinogen complex as is found as it is found in vivo.

TABLE 4
Fibrin network compaction comparison

| Sample | Expelled Supernatant (%) |
|---|---|
| Plasma | 55 |
| Gradiflow ™ | 60 |
| Commercial preparation | 30 |

Compaction of a fibrin matrix is observed by collapsing a clot under uniform gravitational force. The level of collapse is indicative of fibrin fibre cross-linking in network organisation.

The collective organisation of fibrin fibres is indicative of the kinetic process of fibrin polymerisation and clot stabilisation. In vivo, factor XIII assists in the cross-linking of fibres to produce a network that can resist physiological stresses. Traditional purification schemes for fibrinogen attempt to remove all contaminants from solution resulting in a polymerisation process that is not similar to the complex coagulation process of blood.

Fibrinogen Isolation from Cryo-Precipitate 1

Fibrinogen is conventionally purified from plasma by a series of techniques including ethanol precipitation, affinity columns and traditional electrophoresis. This process takes about 48-72 hours and the harsh physical and chemical stresses placed on fibrinogen are believed to denature the molecule, resulting in activity that is removed from that of fibrinogen in plasma.

Cryo-precipitation is the first step in the production of factor VIII and involves the loss of most of the fibrinogen in plasma. Processing of this waste fibrinogen is of considerable interest to major plasma processors and provides an opportunity to demonstrate the rapid purification of fibrinogen from cryo-precipitate using the method according to the present invention.

In this example, cryo-precipitate 1, produced by thawing frozen plasma at 4° C. overnight was removed from plasma by centrifugation at 1000×g. The precipitate was re-dissolved in 80 mM Tris-Borate buffer (pH 8.5) and placed in the upstream of a Gradiflow™ apparatus. A potential of 250 volts was applied across a 1000 kDa cut-off cartridge and run for 1 hour. The downstream was replaced with fresh buffer at 30 minute intervals. The buffer was replaced after phase 1 with a Histidine/MES buffer (pH 6.0) and the apparatus was run at 250 volts reversed potential for a further 1 hour. The downstream was again harvested at 30 minute intervals and replaced with fresh running buffer. The upstream was harvested and concentrated using an Amicon stirred cell ultrafiltration cell. The product was analysed for clotting activity by the addition of thrombin and calcium (final concentrations (10 NIH unit/mL and 10 mM respectively).

Purity of the sample was investigated using reduced SDS PAGE and the presence of fibrinogen confirmed with western analysis. Western blots were stained with DAKO rabbit anti-human fibrinogen conjugated to HRP and developed with 4CN.

Fibrinogen estimation was performed using an in house EIA.

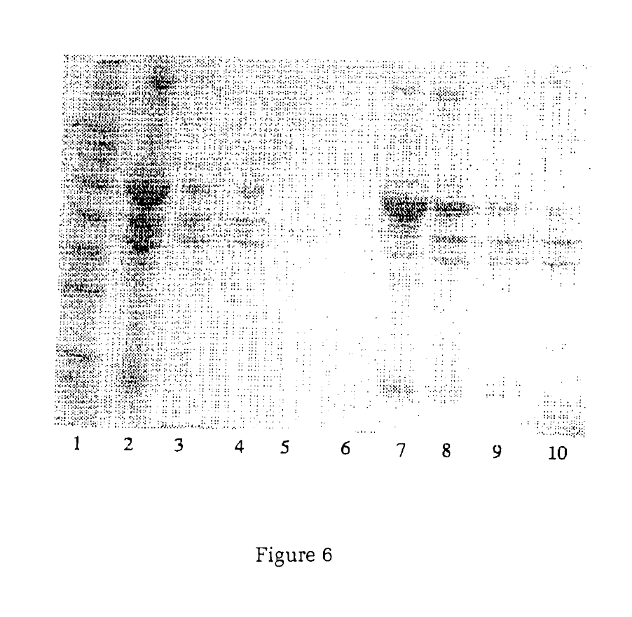

The results of the purification procedure are shown in FIG. 6. The final fibrinogen product had characteristics of native fibrinogen and was substantially indistinguishable from fibrinogen obtained from whole blood by the method according to the present invention.

Gradiflow™ technology allows the rapid purification of fibrinogen from plasma. The fibrinogen appears to retain much of its native characteristics and biological function. The process according to the present invention is scalable and introduces a new and useful means of purifying blood products with high yield and virtually no wastage.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

### REFERENCES

Towbin, 1979. Electrophoretic transfer of proteins from polyacrylamide gels to nitrocellulose sheets: procedure and some applications. Proceedings of the National Academy of Sciences of the USA 76: 4350.
Nair C H and Shah E A 1997. Compaction as a method to characterise fibrin network structure: kinetic studies and relationship to crosslinking. Thromb Res 88: 381.
Carr M E Jr and Hermans J, 1978. Size and density of fibrin from turbidity. Macromolecules 11: 46.
Laemlii, 1970 Nature, 227: 680.
Furlan M, 1984. Purification of Fibrinogen in Beck E A and Furlan M (Eds), Variants of Human Fibrinogen. Hans Huber Publications Berne, pp 133-145.
Shah G A, Nair, C H, Dhall D P (1987). Comparison of fibrin networks in plasma and fibrinogen solution. Thrombosis Research 45: 257

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A method for isolating at least one blood clotting protein from a mixture containing the at least one blood clotting protein and at least one contaminant, the method comprising:
(a) directing a first fluid stream having a selected pH and including the mixture containing at least one blood clotting protein and the at least one contaminant, so as to flow along a first selective membrane, wherein such pH is selected such that the pH is greater than the isoelectric point of the at least one blood clotting protein;
(b) directing a second fluid stream along the first selective membrane so as to be isolated from the first fluid stream thereby;
(c) applying at least one selected electric potential across at least the first and second fluid streams, wherein the application of the at least one selected electric potential causes migration of at least a portion of a selected one of the at least one blood clotting protein and the at least one contaminant through the first selective membrane while at least a portion of the other of the at least one blood clotting protein and the at least one contaminant is prevented from entering the second fluid stream; and
(d) maintaining step (c) until at least one of the fluid streams contains the desired purity of the at least one blood clotting protein.

17. The method according to claim 16 wherein the at least one isolated blood clotting protein substantially mimics the characteristics of natural blood clotting proteins.

18. The method according to claim 16 wherein the mixture is comprised of plasma obtained from human blood and the at least one blood clotting protein is fibrinogen.

19. The method according to claim 16 wherein the first selective membrane has a molecular mass cut-off close to the apparent molecular mass of the blood clotting protein.

20. The method according to claim 16 wherein the pH of the first fluid stream is about 7.0.

21. The method according to claim 16 wherein the method further comprises at least one of periodically stopping the at least one electric potential and reversing the at least one selected electric potential to cause movement of at least any components in the first fluid stream having entered the first selective membrane to move back into the first fluid stream and wherein substantially not causing any components which have entered the second fluid stream to re-enter the first fluid stream.

22. The method according to claim 16 wherein the yield of the at least one blood clotting protein is at least about 70%.

23. The method according to claim 18 wherein the fibrinogen has at least about 95% clottability.

24. The method according to claim 16 wherein the method further comprises
(e) recovering the at least one blood clotting protein isolated from the mixture from at least one of the first and second fluid streams;
(f) providing the at least one blood clotting protein into a third fluid stream and directing the third fluid stream so as to flow along a second selective membrane, wherein the third fluid stream is selected from the group consisting of the first fluid stream and a fluid stream different from the first fluid stream;
(g) directing a fourth fluid stream along the second selective membrane so as to be isolated from the third fluid stream thereby, wherein the fourth fluid stream is selected from the group consisting of the second fluid stream and a fluid stream different from the second fluid stream;
(h) applying at least one selected electric potential across at least the third and fourth fluid streams, wherein the application of the at least one selected electric potential causes migration of at least a portion of a selected one of the at least one blood clotting protein and other components in the third fluid stream through the second selective membrane while at least a portion of the other of the at least one blood clotting protein and other components in the third fluid stream is prevented from entering the fourth fluid stream; and
(i) maintaining step (h) until at least one of the fluid streams contains the desired purity of the at least one blood clotting protein.

25. The method according to claim 24 wherein the at least one isolated blood clotting protein substantially mimics the characteristics of natural blood clotting proteins.

26. The method according to claim 24 wherein the mixture is comprised of plasma obtained from human blood and the at least one blood clotting protein is fibrinogen.

27. The method according to claim 24 wherein the second selective membrane has a larger molecular mass cut-off than the first selective membrane.

28. The method according to claim 24 wherein the pH of the third fluid stream is about 7.0.

29. The method according to claim 24 wherein the yield of the at least one blood clotting protein is at least about 70%.

30. The method according to claim 26 wherein the fibrinogen has at least about 95% clottability.

31. The method according to claim 24 wherein the method further comprises at least one of periodically stopping the at least one electric potential and reversing the at least one selected electric potential to cause movement of at least any components in the third fluid stream having entered the second selective membrane to move back into the third fluid stream and wherein substantially not causing any components which have entered the fourth fluid stream to re-enter the third fluid stream.

32. A method for isolating at least one blood clotting protein from a mixture containing the at least one blood clotting protein and at least one contaminant, the method comprising:
(a) communicating a first fluid volume along a first selective membrane having a characteristic pore size, wherein the first fluid volume includes the mixture containing at least one blood clotting protein and the at least one contaminant, wherein the at least one blood clotting protein and at least one contaminant each have a characteristic size and charge;
(b) communicating a second fluid volume along the first selective membrane so as to be isolated from the first fluid volume thereby;
(c) applying at least one selected electric potential across at least the first and second fluid volumes, wherein the application of the at least one selected electric potential and the characteristic pore size of the first selective membrane causes migration of at least a portion of a selected one of the at least one blood clotting protein and the at least one contaminant through the first selective membrane while at least a portion of the other of the at least one blood clotting protein and the at least one contaminant is prevented from entering the second fluid volume;
(d) maintaining step (c) for a predetermined period; and
(e) recovering from at least one of the fluid volumes a blood clotting protein.

33. The method according to claim 32 wherein at least about 40% of the blood clotting protein is recovered from the mixture.

34. The method according to claim 32 wherein in a clotting test the blood clotting protein recovered produces fibrins in a clot having a mass to length ration similar to that obtained with plasma in a similar clotting test.

35. The method according to claim 32 wherein in a clotting test the blood clotting protein recovered produces a clot having a fibrin network compaction similar to that obtained with plasma is a similar clotting test.

36. The method according to claim 32 wherein the blood clotting protein recovered has a purity of at least about 90%.

37. The method according to claim 32 wherein the mixture is comprised of plasma obtained from human blood and the at least one blood clotting protein is fibrinogen.

38. The method according to claim 32 wherein the method further comprises at least one of periodically stopping the at least one electric potential and reversing the at least one selected electric potential to cause movement of at least any components in the first fluid volume having entered the first selective membrane to move back into the first fluid volume and wherein substantially not causing any components which have entered the second fluid volume to re-enter the first fluid volume.

39. A system for isolating at least one blood clotting protein from a mixture containing the at least one blood clotting protein and at least one contaminant, the system comprising:
means adapted for directing a first fluid stream having a selected pH and including the mixture containing at least one blood clotting protein and the at least one contaminant, so as to flow along a first selective membrane, wherein such pH is selected such that the pH is greater than the isoelectric point of the at least one blood clotting protein;
means adapted for directing a second fluid stream along the first selective membrane so as to be isolated from the first fluid stream thereby; and
means adapted for applying at least one selected electric potential across at least the first and second fluid streams, wherein the application of the at least one selected electric potential causes migration of at least a portion of a selected one of the at least one blood clotting protein and the at least one contaminant through the first selective membrane while at least a portion of the other of the at least one blood clotting protein and the at least one contaminant is prevented from entering the second fluid stream.

40. The system according to claim 39 wherein the at least one isolated blood clotting protein substantially mimics the characteristics of natural blood clotting proteins.

41. The system according to claim 39 wherein the system further comprises:
means adapted for recovering the at least one blood clotting protein isolated from the mixture from at least one of the first and second fluid streams;
means adapted for providing the at least one blood clotting protein into a third fluid stream and directing the third fluid stream so as to flow along a second selective membrane, wherein the third fluid stream is selected from the group consisting of the first fluid stream and a fluid stream different from the first fluid stream;
means adapted for directing a fourth fluid stream along the second selective membrane so as to be isolated from the third fluid stream thereby, wherein the fourth fluid stream is selected from the group consisting of the second fluid stream and a fluid stream different from the second fluid stream; and
means adapted for applying at least one selected electric potential across at least the third and fourth fluid streams, wherein the application of the at least one selected electric potential causes migration of at least a portion of a selected one of the at least one blood clotting protein and other components in the third fluid stream through the second selective membrane while at least a portion of the other of the at least one blood clotting protein and other components in the third fluid stream is prevented from entering the fourth fluid stream.

42. The system according to claim 39 wherein the at least one isolated blood clotting protein substantially mimics the characteristics of natural blood clotting proteins.

43. A system for isolating at least one blood clotting protein from a mixture containing the at least one blood clotting protein and at least one contaminant, the system comprising:
means adapted for communicating a first fluid volume along a first selective membrane having a characteristic pore size, wherein the first fluid volume includes the mixture containing at least one blood clotting protein and the at least one contaminant, wherein the at least one blood clotting protein and at least one contaminant each have a characteristic size and charge;
means adapted for communicating a second fluid volume along the first selective membrane so as to be isolated from the first fluid volume thereby;
means adapted for applying at least one selected electric potential across at least the first and second fluid volumes, wherein the application of the at least one selected electric potential and the characteristic pore size of the first selective membrane causes migration of at least a portion of a selected one of the at least one blood clotting protein and the at least one contaminant through the first selective membrane while at least a portion of the other of the at least one blood clotting protein and the at least one contaminant is prevented from entering the second fluid volume; and
means adapted for recovering from at least one of the fluid volumes a blood clotting protein.

44. Isolated fibrinogen substantially mimicking the characteristics of natural fibrinogen purified according to the method of claim 16.

45. Isolated fibrinogen substantially mimicking the characteristics of natural fibrinogen purified according to the method of claim 32.

46. Isolated fibrinogen substantially having the clotting and functional characteristics of native fibrinogen purified according to the method of claim 16.

47. Isolated fibrinogen substantially having the clotting and functional characteristics of native fibrinogen purified according to the method of claim 32.
